(19) United States
(12) Patent Application Publication
(10) Pub. No.: US 2012/0216621 A1
(43) Pub. Date: Aug. 30, 2012

(54) PHYSICAL QUANTITY DETECTOR AND METHOD OF MANUFACTURING THE SAME

(75) Inventor: Masayuki OTO, Okaya-shi (JP)

(73) Assignee: SEIKO EPSON CORPORATION, Tokyo (JP)

(21) Appl. No.: 13/365,905

(22) Filed: Feb. 3, 2012

(30) Foreign Application Priority Data
Feb. 25, 2011 (JP) 2011-040818
Oct. 18, 2011 (JP) 2011-228908

(51) Int. Cl. G01L 7/08; B32B 37/06

(52) U.S. Cl. 73/715; 156/292

(57) ABSTRACT

A supporting frame section of a diaphragm layer and a fixing section of a pressure sensor are joined using a first joining material. A pair of bases of a pressure sensitive element layer and a pair of supporting sections are joined using a second joining material having a melting point higher than the melting point of the first joining material.

### BACKGROUND

1. Technical Field

The present invention relates to a physical quantity detector and a method of manufacturing the same, and, more particularly to a physical quantity detector excellent in anti-reflow properties and a method of manufacturing the same.

2. Related Art

In the past, there is a physical quantity detector such as a pressure sensor of a diaphragm type including a piezoelectric oscillator used as a force detecting element and a diaphragm that receives pressure (pressure of gas or liquid, etc.) or is pressed by external force and bends. For example, a pressure sensor of a diaphragm type disclosed in JP-A-2008-275445 (Patent Document 1), JP-A-2010-117342 (Patent Document 2), JP-A-2010-164500 (Patent Document 3), and JP-A-2010-164362 (Patent Document 4) includes a diaphragm layer, a base layer (a cover section), and a pressure sensitive element layer functioning as an intermediate layer. A pressure sensitive element including a double tuning fork oscillator is arranged in the center of the pressure sensitive element layer. A pair of supporting sections for fixing a pair of bases arranged at both ends of a pressure sensitive section (an oscillating section) of the pressure sensitive element are provided in the diaphragm layer. The pair of bases are supported by the pair of supporting sections while being fixed by a joining material such as an adhesive. In the pressure sensor of the diaphragm type, when the diaphragm layer that receives pressure to be detected is deflectively displaced, the displacement is converted into force via the diaphragm layer and transmitted to the pressure sensitive element, which is a physical quantity detecting element. Then, the resonant frequency of the pressure sensitive element changes with internal stress (tensile stress or compressive stress) generated on the inside by the transmitted force. The pressure sensor measures fluctuation in the resonant frequency and detects the pressure to be detected.

When the pressure sensor is manufactured, first, the diaphragm layer and the pressure sensitive element layer are joined. Thereafter, the pressure sensitive element layer and the base layer are joined. Patent Document 1 discloses a technique for joining the layers using an adhesive.

When the coefficient of thermal expansion of the joining material used for the joining and the coefficient of thermal expansion of the diaphragm layer, the pressure sensitive element layer, and the base layer are different, thermal strain due to a temperature change occurs. The internal stress changes because of the thermal strain. The resonant frequency of the pressure sensitive element fluctuates according to the change in the internal stress and detection accuracy of the pressure to be measured is deteriorated.

In order to prevent such deterioration in the accuracy of the pressure detection due to the thermal strain, Patent Documents 2 to 4 propose that, when the diaphragm layer, the base layer, and the pressure sensitive element layer are respectively formed of quartz crystal substrates, the coefficient of thermal expansion of the joining material and the coefficient of thermal expansion of quartz crystal are set substantially equal.

If the coefficient of thermal expansion of the diaphragm layer, the pressure sensitive element layer, and the base layer and the coefficient of thermal expansion of the joining material are set substantially equal, even if the temperature of an environment atmosphere in which the pressure sensor is exposed changes and expansion or contraction of the members occurs according to the change in the temperature, the joining material expands or contracts at the same rate (expansion coefficient). Therefore, the internal stress due to the thermal strain does not occur. As a result, the deterioration in the pressure detection accuracy does not occur.

However, when the coefficient of thermal expansion of the joining material is set substantially equal to the coefficient of thermal expansion of the members, problems explained below occur.

When the members of the pressure sensor are quartz crystal crystal, since the quartz crystal is a crystalline material, the coefficient of thermal expansion is about 14 (ppm/K), which is large compared with that of general PbO (lead oxide) low-melting glass used for the joining material. If a filler such as metal oxide is mixed in the PbO low-melting glass, the coefficient of thermal explanation of the PbO low-melting glass can be increased and adjusted to the coefficient of thermal expansion of the quartz crystal. However, a melting point is lowered. After joining the members of the pressure sensor using the low-melting glass, the melting point of which is lowered by adjusting the coefficient of thermal expansion to that of the quartz crystal in this way, the pressure sensor is mounted on a mounting substrate such as a circuit board by high temperature treatment such as reflow. Then, the low-melting glass that joins the pair of bases of the pressure sensitive element and the diaphragm layer re-melts. Fixed points of the pair of bases of the pressure sensitive element and the pair of supporting sections of the diaphragm shift because of the re-melting. The low-melting glass re-hardens in a state in which the shift occurs. Therefore, a degree of thermal strain caused when the temperature of the environment atmosphere changes and expansion or contraction of the members occur according to the change in the temperature is different from a degree of thermal strain before the re-melting. A change occurs in the internal stress that occurs in the pressure sensitive element because of the difference in the thermal strain. Therefore, fluctuation such as drift occurs in a pressure value that should be detected.

### SUMMARY

An advantage of some aspects of the invention is to provide a physical quantity detector that reduces occurrence of drift of a pressure detection value due to high temperature treatment such as reflow and a method of manufacturing the physical quantity detector.

Another advantage of some aspects of the invention is to provide a physical quantity detector that can prevent fluctuation in internal stress due to thermal strain of a pressure sensitive element due to a temperature change and realize highly accurate pressure detection and a method of manufacturing the physical quantity detector.

Still another advantage of some aspects of the invention is to provide a physical quantity detector that enables more highly accurate pressure detection taking into account degrees of influences of re-melting and the coefficient of thermal expansion of a joining material due to high temperature treatment such as reflow and a method of manufacturing the physical quantity detector.

Yet another advantage of some aspects of the invention is to provide a method of manufacturing a physical quantity detector that can more satisfactorily join members using a joining material.

### Application Example 1

This application example of the invention is directed to a physical quantity detector including: a pressure sensitive element including: a pair of bases; and a pressure sensitive section arranged between the pair of bases; a diaphragm including: a flexible section including a pair of supporting sections to which the pair of bases are joined via a second joining material; and a supporting frame section that supports a peripheral edge of the flexible section; and a fixing section to which the supporting frame section is fixed via a first joining material. The melting point of the second joining material is higher than the melting point of the first joining material.

According to this application example, the supporting frame section of the diaphragm and the fixing section are joined using the first joining material, the pair of supporting sections of the diaphragm and the pair of bases of the pressure sensitive element are joined using the second joining material, and the melting point of the second joining material is higher than the melting point of the first joining material. Therefore, when high temperature treatment such as reflow is applied to the physical quantity detector after manufacturing, it is possible to reduce re-melting of the second joining material, reduce fluctuation in internal stress due to thermal strain of the pressure sensitive element caused by the re-melting of the second joining material, and reduce occurrence of drift of a detection value.

### Application Example 2

This application example of the invention is directed to the physical quantity detector according to Application Example 1, wherein a coefficient of thermal expansion of the first joining material and a coefficient of thermal expansion of portions joined by the first joining material are substantially equal.

In the portions joined by the first joining material, the influence of drift of a pressure detection value due to a shift between the coefficients of thermal expansion of the first joining material and the portions joined by the first joining material is larger than the influence of drift of a pressure detection value due to re-melting of the first joining material. Therefore, by adopting the configuration explained above, it is possible to further reduce drift of a detection value due to a temperature change and improve accuracy of the detection value.

### Application Example 3

This application example of the invention is directed to the physical quantity detector according to Application Example 1 or 2, wherein an absolute value of a difference between the coefficients of thermal explanation of the first joining material and portions joined by the first joining material is smaller than an absolute value of a difference between the coefficients of thermal expansion of the second joining material and portions jointed by the second joining material.

According to this configuration, the coefficient of thermal expansion of the first joining material can be set closer to the coefficient of thermal expansion of the portions joined by the first joining material. Therefore, it is possible to further reduce drift of a detection value due to a temperature change and improve accuracy of the detection value.

### Application Example 4

This application example of the invention is directed to the physical quantity detector according to any of Application Examples 1 to 3, wherein the physical quantity detector includes a base including a function of the fixing section. The base and the diaphragm are laminated to cover the pressure sensitive element.

According to this configuration, in the case of a three-layer structure in which the physical quantity detector includes the base including the function of the fixing section and the base and the diaphragm are laminated to cover the pressure sensitive element, as in the case explained above, it is possible to reduce fluctuation in internal stress due to thermal strain of the pressure sensitive element, reduce occurrence of drift of a detection value, and improve accuracy of the detection value.

### Application Example 5

This application example of the invention is directed to the physical quantity detector according to any of Application Examples 1 to 3, wherein the physical quantity detector includes: a frame section that surrounds the pressure sensitive element; and a connecting section that couples the frame section and the pressure sensitive element. The frame section includes a function of the fixing section.

According to this configuration, when the physical quantity detector includes the frame section that surrounds the pressure sensitive element and the connecting section that couples the frame section and the pressure sensitive element, and the frame section includes the function of the fixing section, as in the case explained above, it is possible to reduce fluctuation in internal stress due to thermal strain of the pressure sensitive element, reduce occurrence of drift of a detection value, and improve accuracy of the detection value.

### Application Example 6

This application example of the invention is directed to the physical quantity detector according to Application Example 5, wherein the diaphragm, the frame section, and a base are laminated to cover the pressure sensitive element. The frame section is joined to a joining section of the base opposed to the frame section using the first joining material.

According to this configuration, in the case of a three-layer structure in which the diaphragm, the frame section, and the base are laminated to cover the piezoelectric element, as in the case explained above, it is possible to reduce fluctuation in internal stress due to thermal strain of the pressure sensitive element, reduce occurrence of drift of a detection value, and improve accuracy of the detection value.

### Application Example 7

This application example of the invention is directed to the physical quantity detector according any of Application Examples 1 to 6, wherein portions joined by the first joining material are quartz crystal. The coefficient of thermal expansion of the first joining material is larger than the coefficient of thermal expansion of the second joining material.

Since the coefficient of thermal expansion of quartz crystal is relatively large, when the coefficient of thermal expansion of the first joining material is set larger than the coefficient of thermal expansion of the second joining material, it is possible to reduce a difference between the coefficients of thermal expansion of the first joining material and the portions joined by the first joining material. When the melting point of the second joining material is set higher than the melting point of the first joining material, it is possible to reduce re-melting of the second joining material in performing heating during mounting on a substrate. Therefore, it is possible to suppress drift of a detection value as a whole and improve accuracy of the detection value.

### Application Example 8

This application example of the invention is directed to the physical quantity detector according to any of Application Examples 1 to 7, wherein the second joining material is a glass material.

According to this configuration, since the glass material is used as the second joining material, it is possible to set the melting point of the second joining material higher than temperature in performing heating during mounting on a substrate.

### Application Example 9

This application example of the invention is directed to the physical quantity detector according to Application Example 8, wherein the glass material contains metal particulates.

According to this configuration, it is possible to adjust a melting point and a coefficient of thermal expansion by adjusting an amount of the metal particulates contained in the glass material.

### Application Example 10

This application example of the invention is directed to a method of manufacturing the physical quantity detector according to any of Application Examples 1 to 9. The melting point of the second joining material is higher than heating temperature in mounting the physical quantity detector on a substrate.

According to this configuration, when heating is performed during mounting of the physical quantity detector on the substrate, it is possible to prevent re-melting of the second joining material. It is possible to suppress fluctuation in internal stress due to thermal strain of the pressure sensitive element due to the re-melting of the second joining material, prevent drift of a detection value, and realize highly accurate detection of a physical quantity.

### Application Example 11

This application example of the invention is directed to a method of manufacturing a physical quantity detector including: a pressure sensitive element including: a pair of bases; and a pressure sensitive section arranged between the pair of bases; a diaphragm including: a flexible section including a pair of supporting sections to which the pair of bases are joined via a second joining material; and a supporting frame section that supports a peripheral edge of the flexible section; and a fixing section to which the supporting frame section is fixed via a first joining material having a melting point lower than the melting point of the second joining material, the method including: applying the second joining material to the pair of supporting sections of the diaphragm; provisionally baking the second joining material applied to the pair of supporting sections; applying, more thickly than the thickness of the second joining material, the first joining material to the supporting frame section on a principal plane side on which the supporting section is provided in the diaphragm; provisionally baking the first joining material applied to the supporting frame section; joining the supporting frame section of the diaphragm and the fixing section using the first joining material by heating the first joining material to temperature equal to or higher than the melting point of the first joining material and lower than the melting point of the second joining material; and joining the pair of supporting sections of the diaphragm and the pair of bases of the pressure sensitive element using the second joining material by heating, in a state in which the second joining material and the pair of bases of the pressure sensitive element are set in contact with each other, the second joining material to temperature equal to or higher than the melting point of the second joining material.

According to this configuration, since the melting point of the second joining material is higher than the melting point of the first joining material, in high temperature treatment such as reflow performed after manufacturing of the physical quantity detector, it is possible to prevent re-melting of the second joining material and suppress fluctuation in internal stress due to thermal strain of the pressure sensitive element.

Since the thickness of the application of the first joining material is set larger than the thickness of the second joining material, first, the first joining material having the low melting point melts in a state in contact with a joining region and joins the supporting frame section and the fixing section and then the second joining material having the high melting point melts and joins the pair of supporting sections and the pair of bases. Therefore, it is possible to prevent a problem in that the first joining material having the low melting point is exposed to temperature equal to or higher than the melting point for a long time in a state not in contact with the joining region and is crystallized and cannot join the supporting frame section and the fixing section.

### Application Example 12

This application example of the invention is directed to the method of manufacturing a physical quantity detector according to Application Example 11, wherein, in the joining of the supporting frame section and the fixing section, the first joining material applied to the supporting frame section of the diaphragm and provisionally baked and a frame section surrounding the pressure sensitive section and having a function of the fixing section are brought into contact with each other and heated to temperature equal to or higher than the melting point of the first joining material and lower than the melting point of the second joining material to thereby join the supporting frame section and the frame section using the first joining material.

According to this configuration, since the thicknesses of the application of the first joining material and the second joining material are changed, first, the first joining material having the low melting point melts in a state in contact with the frame section and joins the supporting frame section and the frame section and then the second joining material having the high melting point melts in a state in contact with the pair of bases of the pressure sensitive element and joins the pair of supporting sections and the pair of bases. Therefore, it is possible to prevent a problem in that the first joining material having the low melting point is exposed to temperature equal to or higher than the melting point for a long time in a state not in contact with the frame section and is crystallized and cannot join the supporting frame section and the frame section.

### BRIEF DESCRIPTION OF THE DRAWINGS

The invention will be described with reference to the accompanying drawings, wherein like numbers reference like elements.

FIG. 1 is an exploded perspective view of a pressure sensor according to a first embodiment of the invention.

FIG. 2 is a schematic sectional view for explaining the operation of the pressure sensor according to the first embodiment.

FIG. 3 is an example of a graph showing a relation between a melting point and a coefficient of thermal expansion according to an amount of a filler contained in low-melting glass.

FIG. 4 is a diagram for explaining a procedure for provisionally baking a first joining material and a second joining material in a diaphragm layer.

FIG. 5 is a diagram for explaining a procedure for melting the provisionally-baked first joining material and second joining material to join the diaphragm layer and a pressure sensitive element.

FIG. 6 is a side sectional view of a pressure sensor according to a second embodiment.

FIG. 7 is an A-A sectional view of the pressure sensor shown in FIG. 6.

FIG. 8 is a side sectional view of a pressure sensor according to a third embodiment.

FIG. 9 is an exploded perspective view of a pressure sensor according to a modification.

FIG. 10A is a disassembled perspective view of a pressure sensor according to another modification including an AT cut oscillator as a pressure sensitive section.

FIG. 10B is a schematic sectional view of the pressure sensor.

FIG. 10C is a plan view of a pressure sensitive element layer included in the pressure sensor.

### DESCRIPTION OF EXEMPLARY EMBODIMENTS

Exemplary embodiments of the invention are explained in detail below with reference to the accompanying drawings.

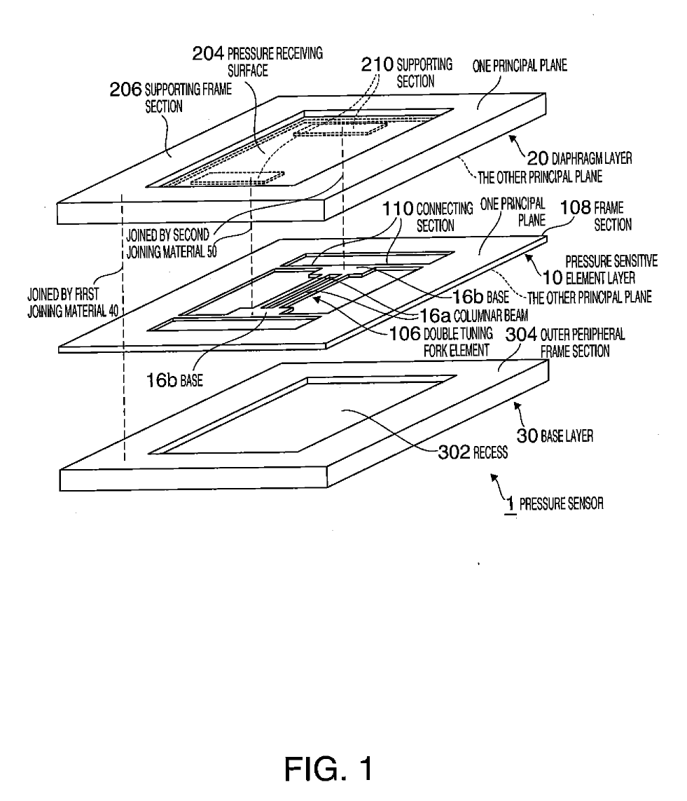

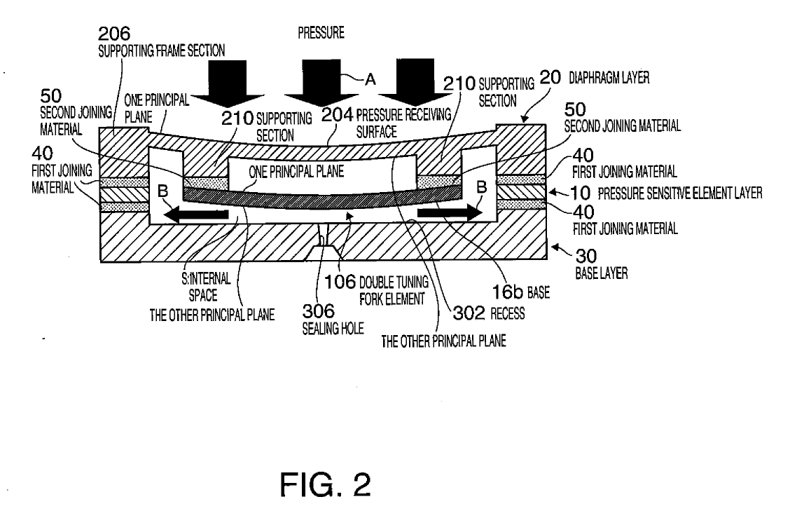

FIG. 1 is an exploded perspective view of a pressure sensor according to a first embodiment. FIG. 2 is a schematic sectional view for explaining the operation of the pressure sensor. In FIG. 1, joining materials are not shown.

As shown in FIG. 1, a pressure sensor 1 includes a pressure sensitive element layer 10 and a diaphragm layer (corresponding to “diaphragm”) 20 and a base layer (corresponding to “base”) 30 that respectively cover to hermetically seal one principal plane side and the other principal plane side of the pressure sensitive element layer 10. The layers 10, 20, and 30 include quartz crystal substrates as base materials.

The pressure sensitive element layer 10 includes, in the center thereof, a double tuning fork element 106 functioning as a pressure sensitive element and includes a frame section 108 having a frame shape that surrounds the double tuning fork element 106. In this embodiment, the frame section 108 corresponds to “fixing section”. The double tuning fork element 106 includes a pair of parallel columnar beams 16a functioning as a pressure sensitive section and a pair of bases 16b connected to both ends of the columnar beams 16a. The double tuning fork element 106 is a pressure sensitive element of a frequency changing type, the resonant frequency of which changes when tensile stress or compressive stress is applied to the columnar beams 16a, and is a so-called piezoelectric oscillator of a double tuning fork type.

The frame section 108 is coupled to the double tuning fork element 106 via a pair of beam-like connecting sections 110 extending from the bases 16b in a direction orthogonal to the columnar beams 16a.

In the double tuning fork element 106, a not-shown excitation electrode and an extracting electrode (a lead electrode) extended from the excitation electrode are provided. The extracting electrode is drawn out to the frame section 108 via the connecting sections 110.

The diaphragm layer 20 includes, on one principal plane side, a pressure receiving surface 204 that receives pressure to be measured. The pressure receiving surface 204 is a flexible section having flexibility. When the pressure to be measured is received from the outside, the pressure receiving surface 204 is deflectively deformed. A supporting frame section 206 having a frame shape is formed at the peripheral edge of the pressure receiving surface 204. The supporting frame section 206 is arranged to be opposed to the frame section 108 of the pressure sensitive element layer 10.

On the other principal plane side of the diaphragm layer 20, i.e., on a principal plane on a sealing side on the rear side of the pressure receiving surface 204, a pair of supporting sections 210 for fixing the pair of bases 16b of the double tuning fork element 106, converting the pressure to be measured received by the pressure receiving surface 204 into force according to the deflective deformation of the pressure receiving surface 204, and transmitting the force to the double tuning fork element 106 are provided.

The supporting sections 210 of the diaphragm layer 20 and the bases 16b of the double tuning fork element 106 are joined via a second joining material 50.

The supporting frame section 206 on the other principal plane side of the diaphragm layer 20 and the frame section 108 on one principal plane side of the pressure sensitive element layer 10 are joined via a first joining material 40.

In this embodiment, low-melting glass containing metal particulates is used for the first joining material 40 and the second joining material 50. Further, in the first joining material 40 and the second joining material 50, contents of the metal particulates are set different. In this embodiment, PbO (lead oxide) is used as the metal particulates contained in the joining materials. The contained metal particulates are not limited to PbO and may be, for example, titanium, bismuth, silver oxide, and the like. When the first joining material 40 and the second joining material 50 are respectively applied to the joining sections, the first joining material 40 and the second joining material 50 are dissolved in an organic solvent into paste materials and used.

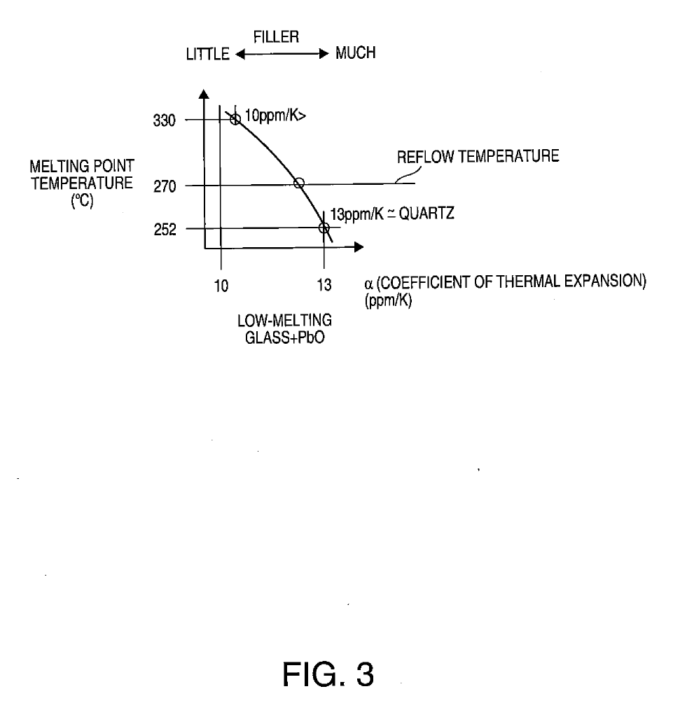

FIG. 3 is an example of a graph showing a relation between a melting point (° C.) and a coefficient of thermal expansion (ppm/K) corresponding to an amount of a filler (metal particulates) contained in the low-melting glass. As shown in FIG. 3, for example, when the content of the filler in the low-melting glass is small and the melting point is 330° C., the coefficient of thermal expansion is only slightly larger than 10 ppm/K. On the other hand, when the content of the filler in the low-melting glass is increased and the melting point is raised to 252° C., the coefficient of thermal expansion increases to 13 ppm/K. As the content of the filler in the low-melting glass is larger, the melting point is lower and the coefficient of thermal expansion is larger. By adjusting an amount of the filler contained in the low-melting glass making use of such a relation, it is possible to adjust the melting point and the coefficient of thermal expansion of the low-melting glass.

In this embodiment, the melting point of the second joining material 50 is set to 320° C. and the coefficient of thermal expansion of the second joining material 50 is set to 11 ppm/K. The temperature of reflow in mounting the pressure sensor 1 on an amounting substrate such as a circuit board is about 270° C. Therefore, when the melting point of the second joining material 50 is set to 320° C., the second joining material 50 does not re-melt because of the reflow.

The double tuning fork element 106 is susceptible to the influence of a change in internal stress due to thermal strain and drift of a pressure detection value tends to occur. Therefore, re-melting of the second joining material 50 for joining the double tuning fork element 106 to the diaphragm layer 20 is prevented. This makes it possible to prevent the drift of the pressure detection value and realize highly accurate pressure detection.

Specifically, when heating temperature is set to 270° C. and the pressure sensor according to the embodiment is mounted on the circuit board by reflow, the low-melting glass that joins the pair of bases of the pressure sensitive element and the diaphragm layer does not melt because the melting point temperature is 320° C.

This makes it possible to prevent a shift between fixing points of the pair of bases of the pressure sensitive element and the pair of supporting sections of the diaphragm layer from occurring because of melting of the low-melting glass.

Therefore, in the pressure sensor according to the invention, during manufacturing of the pressure sensor and after the reflow, a difference does not occur in a degree of thermal strain that occurs when the temperature of an environment atmosphere changes and the members expand or contract according to the temperature change. Consequently, the pressure sensor displays an excellent effect that it is possible to prevent the problem of the pressure sensor having the structure of the related art, i.e., the problem in that fluctuation such as drift in a pressure value that should be detected is caused by a change in internal stress that occurs in the pressure sensitive element because of the reflow.

The values of the melting point and the coefficient of thermal expansion of the second joining material 50 explained above are only an example. If an amount of the metal particulates contained in the low-melting glass is adjusted to increase and set the coefficient of thermal expansion of the second joining material 50 closer to the coefficient of thermal expansion of quartz crystal while lowering the melting point of the second joining material 50 in a range in which the melting point is not equal to or lower than reflow temperature, it is possible to further reduce the drift of the pressure detection value.

On the other hand, in this embodiment, the melting point of the first joining material 40 is set to 252° C. and the coefficient of thermal expansion of the first joining material 40 is set to 13 ppm/K. In the first joining material 40, an amount of the metal particulates mixed therein is set larger than that in the second joining material 50. Therefore, the melting point is lower and the coefficient of thermal expansion is larger than those of the second joining material 50.

The coefficient of thermal expansion of quartz crystal is about 14 ppm/K in a temperature range from the room temperature to 120° C. in a Z cut substrate (a substrate in which a Z axis (an optical axis) is orthogonal to a principal plane), which is a substrate in which a plane including an X axis (an electrical axis) and a Y axis (a mechanical axis) and a principal plane are parallel, generally used in a piezoelectric oscillator of a tuning fork type or a quartz crystal substrate sliced at a cut angle obtained by rotating the Z cut substrate several degrees with an X axis of quartz crystal as a rotation axis such that peak temperature (turnover temperature) of a quadratic curve convex upward indicating a frequency temperature characteristic of the piezoelectric oscillator of the tuning fork type is in the middle of an operating temperature range. According to knowledge obtained from a result of an experiment carried out by the inventor of this application, it is confirmed that the coefficients of thermal expansion are effective if the coefficients of thermal expansion are matched in a range within ±1 ppm/K. It is also found that, when higher detection accuracy is necessary, it is suitable to match the coefficients of thermal expansion in a range within ±0.1 ppm/K.

An area of the frame section 108 on the one principal plane side of the pressure sensitive element layer 10 joined by the first joining material 40 (an area of the supporting frame section 206 on the other principal plane side of the diaphragm layer 20) is larger than an area of the bases 16b of the pressure sensitive element layer 10 joined by the second joining material 50 (an area of the supporting sections 210 of the diaphragm layer 20). Therefore, concerning the deterioration in pressure detection accuracy, the influence due to a shift between the coefficients of thermal expansion of the first joining material 40 and the portions jointed by the first joining material 40 is larger than the influence of re-melting by reflow. Therefore, even if the melting point of the first joining material 40 falls lower than the reflow temperature and the first joining material 40 is likely to re-melt during high temperature treatment such as reflow, priority is given to adjusting the coefficients of thermal expansion to that of quartz crystal. Consequently, it is possible to reduce drift of a pressure detection value due to a temperature change and improve accuracy of the pressure detection value.

As explained above, when the quartz crystal substrates are used as the base materials in the pressure sensitive element layer 10 and the diaphragm layer 20, the second joining material 50 having the small coefficient of thermal expansion and the high melting point is used for the joining of the supporting sections 210 and the bases 16b on which the influence of drift of a pressure detection value due to re-melting of the joining material is large. The first joining material 40 having the large coefficient of thermal explanation and the low melting point is used for the joining of the frame section 108 of the pressure sensitive element layer 10 and the supporting frame section 206 of the diaphragm layer on which the influence due to a shift between the coefficients of thermal expansion is large. This makes it possible to improve accuracy of a pressure detection value as a whole.

In this way, the two kinds of joining materials having the different melting points and the different coefficients of thermal expansion are properly used. This makes it possible to provide the pressure sensor 1 in which drift of a pressure detection value is not caused by high temperature treatment such as reflow while deterioration in pressure detection accuracy due to a temperature change is prevented.

When the base materials of the pressure sensitive element layer 10 and the diaphragm layer 20 are other than the quartz crystal substrates, concerning the coefficients of thermal expansion, an absolute value of a difference between the coefficients of thermal expansion of the first joining material 40 and the portions (the supporting frame section 206 and the frame section 108) joined by the first joining material 40 is set smaller than an absolute value of a difference between the coefficients of thermal expansion of the second joining material 50 and the portions (the supporting sections 210 and the bases 16b) joined by the second joining material 50. As a result, effects same as those explained above can be obtained.

The base layer 30 is a member for sealing an internal space S in which the double tuning fork element 106 is housed. The base layer 30 is arranged to cover the other principal plane side of the pressure sensitive element layer 10. A recess 302 for forming the internal space S is formed on the principal plane on the pressure sensitive element layer 10 side of the base layer 30. An outer peripheral frame section 304 having a frame shape is provided to surround the recess 302. The outer peripheral frame section 304 is joined to the frame section 108 on the other principal plane side via the first joining material 40. The outer peripheral frame section 304 is used as a joining section. In this embodiment, the diaphragm layer 20, the frame section 108 of the pressure sensitive element layer 10, and the base layer 30 configure a container. The internal space S is formed by a space surrounded by the diaphragm layer 20, the frame section 108 of the pressure sensitive element layer 10, and the base layer 30.

A sealing hole 306 piercing through the base layer 30 in the thickness direction is provided in the center of the base layer 30. The sealing hole 306 is used to bring the internal space S into a vacuum state.

An area of the frame section 108 on the other principal plane side of the pressure sensitive element layer 10 joined by the first joining material 40 (an area of the outer peripheral frame section 304 of the base layer 30) is larger than an area of the bases 16b of the pressure sensitive element layer 10 joined by the second joining material 50 (an area of the supporting sections 210 of the diaphragm layer 20). Therefore, as explained above, the influence of drift of a pressure detection value due to a shift between the coefficients of thermal expansion of the first joining material 40 and the portions joined by the first joining material 40 is larger than the influence of drift of a pressure detection value due to re-melting of the first joining material 40. Therefore, when the outer peripheral frame section 304 of the base layer 30 and the frame section 108 on the other principal plane side of the pressure sensitive element layer 10 are joined, the first joining material 40 that has the low melting point and is likely to re-melt during high temperature treatment such as reflow but has the coefficient of thermal expansion adjusted to that of quartz crystal is used. This makes it possible to reduce drift of a pressure detection value due to a temperature change and improve accuracy of the pressure detection value.

When the base materials of the pressure sensitive element layer 10 and the base layer 30 are other than the quartz crystal substrates, concerning the coefficients of thermal expansion, an absolute value of a difference between the coefficients of thermal expansion of the first joining material 40 and the portions (the outer peripheral frame section 304 and the frame section 10B) joined by the first joining material 40 is set smaller than an absolute value of a difference between the coefficients of thermal expansion of the second joining material 50 and the portions (the supporting sections 210 and the bases 16b) joined by the second joining material 50. As a result, effects same as those explained above can be obtained.

Although not shown in the figure, an electrode terminal is provided on a surface of the base layer 30 exposed to the outside. The electrode terminal performs input and output of signals between the electrode terminal and the double tuning fork element 106 via a not-shown conductive pattern.

The pressure sensor 1 configured as explained above is a sensor that detects absolute pressure, the inside of which is hermetically sealed and maintained in a vacuum state.

A basic operation of the pressure sensor 1 is explained with reference to FIG. 2. As shown in FIG. 2, when the pressure sensor 1 receives pressure from the outside, the pressure receiving surface 204 of the diaphragm layer 20 bends in an arrow A direction. According to the bending of the pressure receiving surface 204 of the diaphragm layer 20, the supporting sections 210 of the diaphragm layer 20 are displaced in an arrow B direction in which a space between the supporting sections 210 increases.

Consequently, in the columnar beams 16a, which is the pressure sensitive section, of the double tuning fork element 106 joined while being laid over between the supporting sections 210, tensile force is applied in the arrow B direction and tensile stress for displacement is generated. Therefore, the resonant frequency of the double tuning fork element 106 increases.

On the other hand, when the pressure from the outside is lower than the pressure in the vacuum state of the inside of the pressure sensor 1, the pressure receiving surface 204 of the diaphragm layer 20 bends in a direction on the opposite side of the arrow A. The supporting sections 210 are displaced in a direction on the opposite side of the arrow B in which a space between the supporting sections 210 decreases.

Consequently, compressive force is applied to the double tuning fork element 106 and compressive stress for displacement is generated. Therefore, the resonant frequency of the double tuning fork element 106 decreases.

The double tuning fork element 106 is electrically connected to a not-shown oscillation circuit and oscillates at a peculiar resonant frequency with an AC voltage supplied from the oscillation circuit. The oscillation circuit outputs an electric signal indicating the resonant frequency of the double tuning fork element 106. Not-shown calculating means calculates pressure from a change in the resonant frequency indicated by the signal. Since the change in the resonant frequency is large with respect to force applied to the double tuning fork element 106, the double tuning fork element 106 can detect pressure with high sensitivity. Specifically, in the piezoelectric oscillator of the double tuning fork type, compared with, for example, a thickness shear oscillator employing AT cut quartz crystal, a change in a resonant frequency due to expansion and compression stress generated in the pressure sensitive section (the columnar beams) is extremely large and variable width of the resonant frequency is large. Therefore, the piezoelectric oscillator of the double tuning fork type is a suitable pressure sensitive element in a force sensor excellent in resolving power for detecting a slight difference between physical quantities (pressure difference).

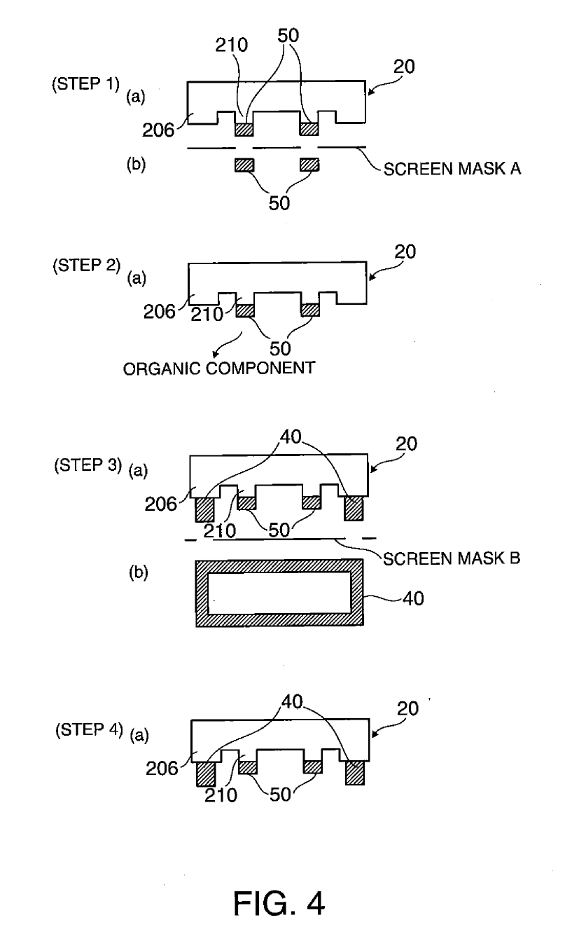

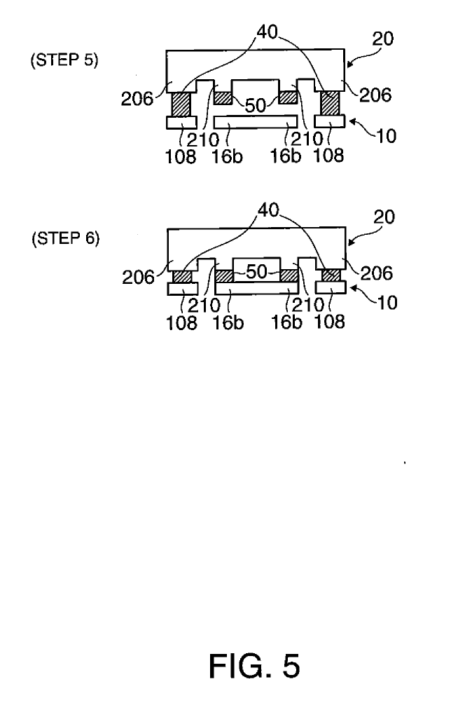

An example of a method of manufacturing the pressure sensor 1 is explained with reference to FIGS. 4 and 5. First, a procedure for provisionally baking the second joining material 50 and the first joining material 40 in the diaphragm layer 20 is explained with reference to FIG. 4. A schematic sectional view of the diaphragm layer 20 is shown in (a) of steps shown in FIG. 4. A plan view of the diaphragm layer 20 viewed from the other principal plane side is shown in (b) of the steps. The diaphragm layer 20 is formed by a processing method such as a photolithography method, an etching method, or a sandblast method.

First, the second joining material 50 dissolved in an organic solvent into a paste state is applied to the surfaces of the pair of supporting sections 210 of the diaphragm layer 20 using a screen mask A (step 1).

Subsequently, the second joining material 50 is provisionally baked at temperature of about 390° C. At this point, an organic component is volatilized from the second joining material 50 (step 2).

The first joining material 40 dissolved in an organic solvent into a paste state is applied to the supporting frame section 206 on the other principal plane side of the diaphragm layer 20 more thickly than the second joining material 50 using a screen mask B (step 3).

The first joining material 40 is provisionally baked at 290° C. (step 4).

A procedure for melting the provisionally baked first joining material 40 and second joining material 50 to join the diaphragm layer 20 and the pressure sensitive element layer 10 is explained. Figures shown in steps in FIG. 5 are schematic sectional views of the diaphragm layer 20.

First, the provisionally baked first joining material 40 in the diaphragm 20 and the frame section 108 of the pressure sensitive element layer 10 are brought into contact with each other. The first joining material 40 is heated at temperature equal to or higher than the melting point of the first joining material 40 (260° C.) and lower than the melting point of the second joining material 50 (320° C.), for example, at temperature of 280° C. for about ten minutes and melted. The supporting frame section 206 of the diaphragm layer 20 and the frame section 108 of the pressure sensitive element layer 10 are joined by the first joining material 40 (step 5, a first joining step).

Since the first joining material 40 is melted in step 5, the second joining material 50 of the diaphragm layer 20 and the bases 16b of the pressure sensitive element layer 10 come into contact with each other. In this state, the second joining material 50 is heated at temperature equal to or higher than the melting point of the second joining material 50 (320° C.), for example, at temperature of 330° C. for about ten minutes and melted. The supporting sections 210 of the diaphragm layer 20 and the bases 16b of the pressure sensitive element layer 10 are joined by the second joining material 50 (step 6, a second joining step).

According to the method of manufacturing the pressure sensor 1 explained above, first, the first joining material 40 having the low melting point melts in a state in contact with the pressure sensitive element layer 10 and joins the supporting frame section 206 and the frame section 108 and then the second joining material 50 having the high melting point melts in a state in contact with the pressure sensitive element layer 10 and joins the supporting sections 210 and the bases 16b. Therefore, it is possible to prevent a problem in that the first joining material 40 having the low melting point is exposed to temperature equal to or higher than the melting point for a long time in a state not in contact with the pressure sensitive element layer 10 and is crystallized and cannot join the supporting frame section 206 and the frame section 108.

Joining of the pressure sensitive element layer 10 and the base layer 30 by the first joining material 40 performed after the procedure can be performed by combining the third step and the sixth step, which are steps for joining the pressure sensitive element layer 10 and the diaphragm layer 20 using the first joining material 40.

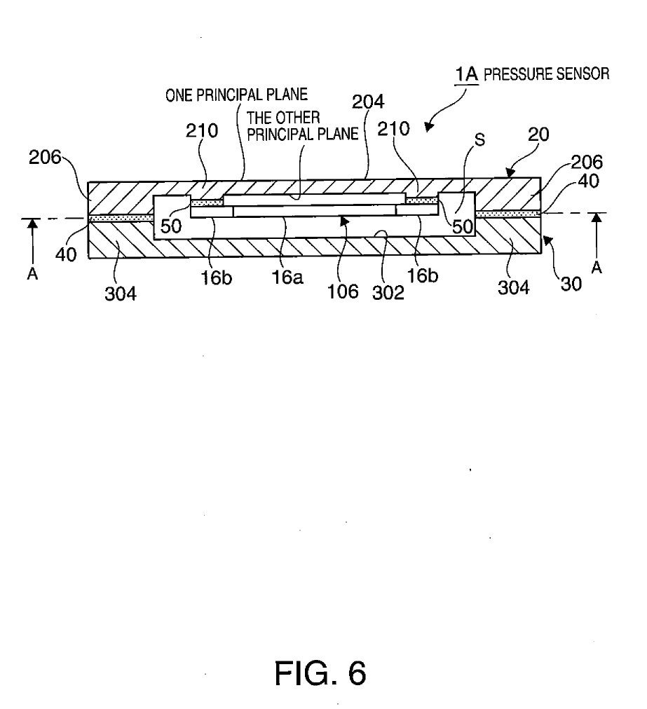

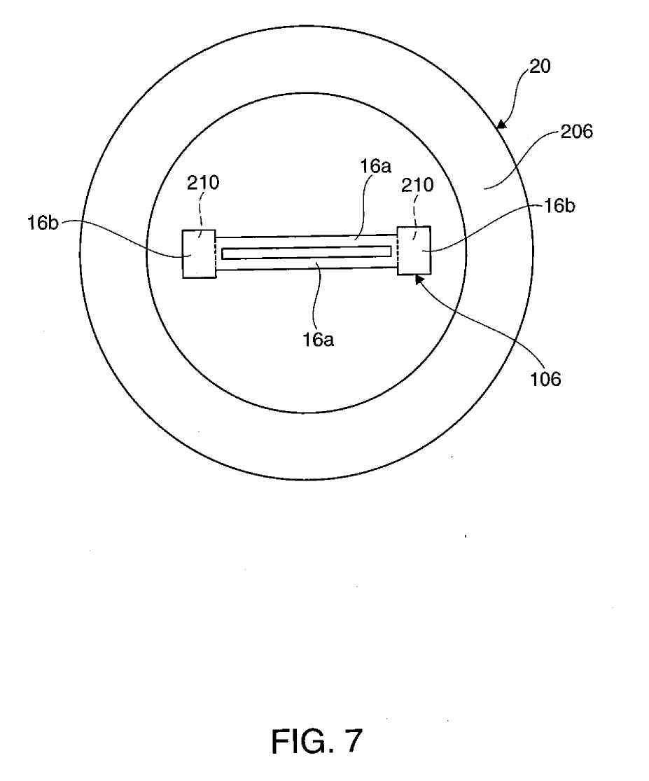

A second embodiment is explained. FIG. 6 is a side sectional view of a pressure sensor 1A according to the second embodiment. FIG. 7 is an A-A sectional view of the pressure sensor 1A shown in FIG. 6. In these figures, components same as the components explained in the first embodiment are denoted by the same reference numerals and signs and explanation of the components is omitted.

The second embodiment is different from the first embodiment in that the pressure sensor 1A according to the second embodiment does not include the frame section 108 that surrounds the double tuning fork element 106 and the connecting sections 110 that couple the frame section 108 and the double tuning fork element 106. Therefore, in the first embodiment, the frame section 108 corresponds to “fixing section” and the supporting frame section 206 of the diaphragm layer 20 and the outer peripheral frame section 304 of the base layer 30 opposed to the supporting frame section 206 are joined across the frame section 108 of the pressure sensitive element layer 10 using the first joining material 40 to form the three-layer structure. However, in the second embodiment, the base layer 30 corresponds to “fixing section” and the supporting frame section 206 of the diaphragm layer 20 and the outer peripheral frame section 304 of the base layer 30 opposed to the supporting frame section 206 are joined using the first joining material 40 to form a two-layer structure.

In the second embodiment, the diaphragm layer 20, and the base layer 30 configure a container. The internal space S is formed by a space surrounded by the diaphragm layer 20 and the base layer 30.

As a method of manufacturing the pressure sensor 1A, a method same as the method in the first embodiment can be used. However, in a step in the second embodiment corresponding to step 5 shown in FIG. 5 in the first embodiment, in a state in which one principal plane of the diaphragm layer 20 is faced upward, when the supporting frame section 206 of the diaphragm layer 20 and the outer peripheral frame section 304 of the base layer 30 are set in contact with each other via the first joining material 40, since a frame section is absent around the double tuning fork element 106 in the second embodiment, the double tuning fork element 106 cannot be supported in the internal space S. Therefore, in the second embodiment, step 5 and subsequent steps only have to be performed, in a state in which the other principal plane of the diaphragm layer 20 is faced upward, with the pair of bases 16b of the double tuning fork element 106 placed on the pair of supporting sections 210 of the diaphragm layer 20 and the outer peripheral frame section 304 of the base layer 30 placed on the supporting frame section 206 of the diaphragm layer 20.

The other components are the same as those in the first embodiment.

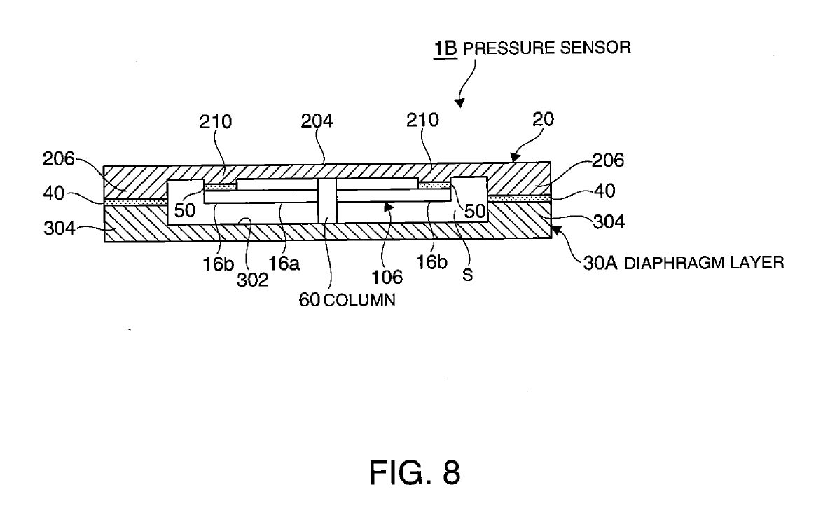

A third embodiment is explained. FIG. 8 is a side sectional view of a pressure sensor 1B according to the third embodiment. In the figure, components same as the components explained in the first and second embodiments are denoted by the same reference numerals and signs and explanation of the components is omitted.

The pressure sensor 1B according to the third embodiment is different from the pressure sensor 1A according to the second embodiment in that, whereas the pressure sensor 1A according to the second embodiment is an absolute pressure gauge, the pressure sensor 1B according to the third embodiment is a relative pressure gauge.

The pressure sensor 1B according to the third embodiment includes a diaphragm layer 30A instead of the base layer 30 included in the pressure sensor 1A according to the second embodiment. Between the diaphragm layer 20 and the diaphragm layer 30A, columns 60 for transmitting deformation of one diaphragm layer to the other are provided. The columns 60 only have to be arranged on both sides of the double tuning fork element 106.

In the pressure sensor 1B having such a configuration, when pressure is applied to the diaphragm 20 side, the pressure receiving surface 204 is deformed to the lower side in the figure. Consequently, the double tuning fork element 106 fixed to the supporting sections 210 receives tensile force and the frequency of the double tuning fork element 106 increases. On the other hand, when pressure is applied to the diaphragm layer 30A side, a principal plane of the diaphragm layer 30A is deformed to the upper side in the figure. Since the columns 60 are provided, the pressure receiving surface 204 of the diaphragm layer 20 is also deformed to the upper side in the figure according to the deformation of the diaphragm layer 30A. Consequently, since the pair of supporting sections 210 tilt toward the center direction, the double tuning fork element 106 fixed to the supporting sections 210 receives compressive force and the frequency of the double tuning fork element 106 decreases. In this way, irrespective of to which of the diaphragm layers 20 and 30A pressure is applied, the pressure sensor 1B can detect the pressure. The other components are the same as those in the second embodiment.

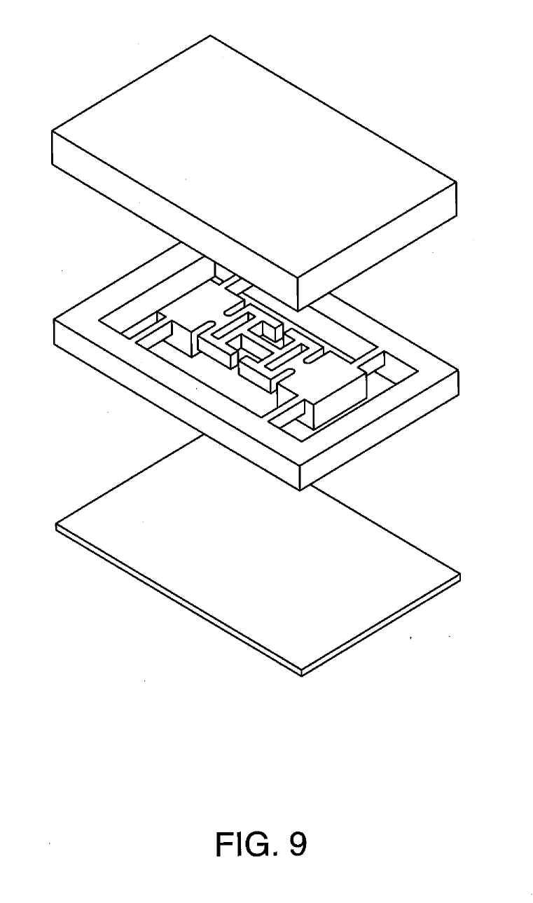

In the embodiments, the pair of columnar beams 16a are used as the pressure sensitive section. However, the pressure sensitive section is not limited to this. For example, as shown in FIG. 9, the pressure sensitive section may be configured by one columnar beam (also referred to as single beam).

A thickness shear oscillator employing AT cut quartz crystal (hereinafter referred to as AT cut oscillator) may be used as the pressure sensitive section. When the AT cut oscillator is used as the pressure sensitive section, frequency stability with respect to temperature is improved. It is possible to obtain satisfactory frequency temperature characteristics and obtain a strong pressure sensor robust against impact.

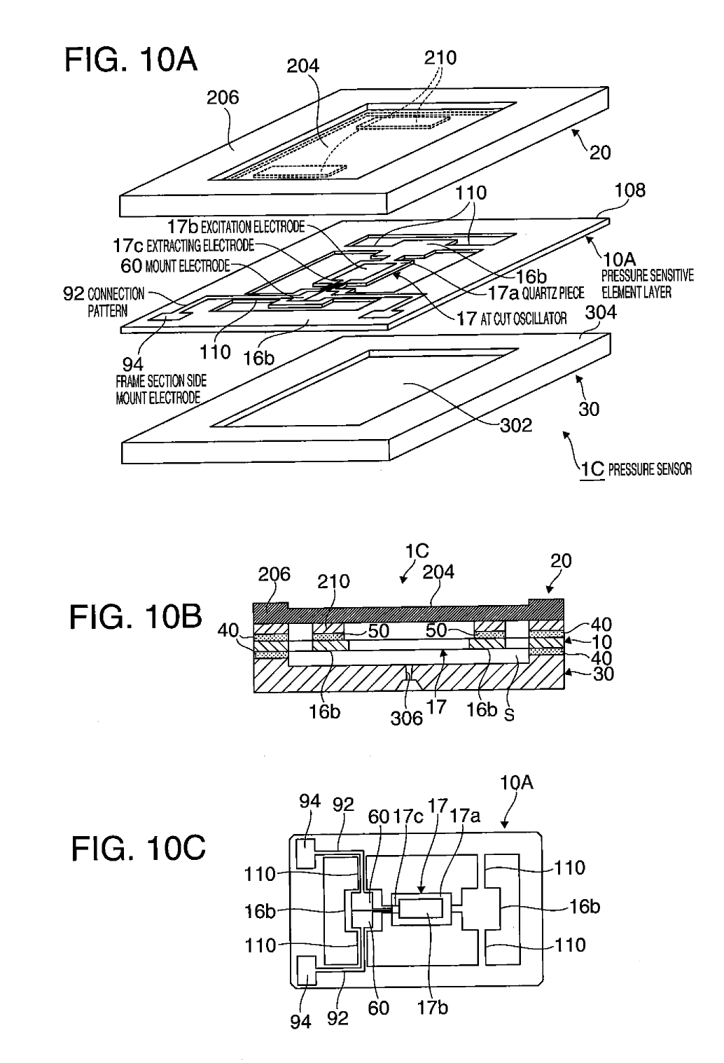

In FIG. 10A, an example of a disassembled perspective view of a pressure sensor 1C employing the AT cut oscillator as the pressure sensitive section is shown. In FIG. 10B, a schematic sectional view of the pressure sensor 10 is shown in FIG. 10B. In FIG. 100, a plan view of a pressure sensitive element layer 10A included in the pressure sensor 1C is shown. In these figures, components same as the components explained in the first to third embodiments are denoted by the same reference numerals and signs and explanation of the components is omitted. As shown in these figures, the pressure sensor 1C has a configuration in which the pair of columnar beams 16a of the double tuning fork oscillator 106 included in the pressure sensor 1 according to the first embodiment are replaced with an AT cut oscillator 17.

The AT cut oscillator 17 includes a quartz crystal piece 17a sliced at a cut angle called AT cut. The AT cut means a cut angle for slicing a plane obtained by rotating a plane (Y plane) including an X axis and a Z axis, which are crystal axes of quartz crystal, in a −Y axis direction from a +Z axis direction with the X axis as a rotation axis by about 35 degrees and 15 minutes such that the plane becomes a principal plane. In the center of the front surface and the rear surface (not shown) of the quartz crystal piece 17a, an excitation electrode 17b for exciting the quartz crystal piece 17a is provided. An extracting electrode 17c is connected to the excitation electrode 17b. The extracting electrode 17c is drawn out toward a peripheral edge in one side in the length direction of the quartz crystal piece 17a. The extracting electrode 17c is conducted to, via a mount electrode 60 provided in the bases 16b and a connection pattern 92 provided in the connecting sections 110 and the frame section 108, a frame section side mount electrode 94 provided in the frame section 108. The frame section side mount electrode 94 is provided in a position overlapping the supporting frame section 206 of the diaphragm layer 20 and the outer peripheral frame section 304 of the base layer 30 in plan view when the pressure sensitive element layer 10A is held between the diaphragm layer 20 and the base layer 30. The frame section side mount electrode 94 is conducted to an electrode provided on the outside of the pressure sensor 1A through a not-shown connection pattern.

Such a pressure sensor 1C operates in the same manner as the pressure sensor 1 explained with reference to FIG. 2 in the first embodiment. Specifically, when the diaphragm layer 20 receives pressure to be detected and is deflectively displaced, the displacement is converted into force via the diaphragm layer 20 and transmitted to the AT cut oscillator 17. Internal stress (tensile stress or compressive stress) is generated in the AT cut oscillator 17 to which the force is transmitted. The resonant frequency of the AT cut oscillator 17 changes. It is possible to measure the change in the resonant frequency to detect the pressure to be detected.

As explained above, when the quartz crystal substrates are used as the base materials in the members included in the pressure sensor, in the second joining material 50 that joins the double tuning fork element 106 functioning as the pressure sensitive element, the coefficient of thermal expansion is set small and a difference between the coefficient of thermal expansion and the coefficient of thermal expansion of quartz crystal is set large. However, second joining material 50 is prevented from re-melting in high temperature treatment such as reflow by setting the melting point higher than the melting point of the first joining material 40. This makes it possible to suppress fluctuation in internal stress due to thermal strain of the pressure sensitive element mounted on the diaphragm.

Concerning the joining of the frame sections of the members included in the pressure sensor, the influence due to a shift between the coefficients of thermal expansion of the first joining material 40 and the portions jointed by the first joining material 40 is larger than the influence of drift of a pressure detection value due to re-melting of the first joining material 40. Therefore, by joining the frame sections using the first joining material 40 having the coefficient of thermal expansion closer to the coefficient of thermal expansion of quartz crystal, it is possible to prevent drift of a pressure detection value due to the shift between the coefficients of thermal expansion and improve accuracy of the pressure detection value.

During manufacturing of the pressure sensor, the thickness of the first joining material 40 before heating is set larger than the thickness of the second joining material 50. This makes it to first melt the first joining material 40 having the low melting point in a state in contact with the pressure sensitive element layer 10 and then melt the second joining material 50 having the high melting point in a state in contact with the pressure sensitive element layer 10. Therefore, it is possible to prevent a problem in that the first joining material 40 having the low melting point is exposed to temperature equal to or higher than the melting point for a long time in a state not in contact with a joining target region and is crystallized and cannot join the frame sections.

The embodiments are explained using the pressure sensor that detects the pressure of gas or liquid. However, the physical quantity detector according to the invention is not limited to this. It goes without saying that the physical quantity detector can be widely applied to a force sensor that detects external force generated by direct pressing by a finger or the like and sensors that detect other physical quantities.

The entire disclosures of Japanese Patent Application No. 2011-040818, filed Feb. 25, 2011 and Japanese Patent Application No. 2011-228908, filed Oct. 18, 2011 are expressly incorporated by reference herein.

1. A physical quantity detector comprising:
a pressure sensitive element including:
a pair of bases; and
a pressure sensitive section arranged between the pair of bases;
a diaphragm including:
a flexible section including a pair of supporting sections to which the pair of bases are joined via a second joining material; and
a supporting frame section that supports a peripheral edge of the flexible section; and
a fixing section to which the supporting frame section is fixed via a first joining material,
wherein a melting point of the second joining material is higher than a melting point of the first joining material.

2. The physical quantity detector according to claim 1, wherein a coefficient of thermal expansion of the first joining material and a coefficient of thermal expansion of portions joined by the first joining material are substantially equal.

3. The physical quantity detector according to claim 1, wherein an absolute value of a difference between coefficients of thermal explanation of the first joining material and portions joined by the first joining material is smaller than an absolute value of a difference between coefficients of thermal expansion of the second joining material and portions jointed by the second joining material.

4. The physical quantity detector according to claim 1, further comprising a base including a function of the fixing section, wherein
the base and the diaphragm are laminated to cover the pressure sensitive element.

5. The physical quantity detector according to claim 1, further comprising:
a frame section that surrounds the pressure sensitive element; and
a connecting section that couples the frame section and the pressure sensitive element, wherein
the frame section includes a function of the fixing section.

6. The physical quantity detector according to claim 5, wherein
the diaphragm, the frame section, and a base are laminated to cover the pressure sensitive element, and
the frame section is joined to a joining section of the base opposed to the frame section using the first joining material.

7. The physical quantity detector according to claim 1, wherein
portions joined by the first joining material are quartz crystal, and
a coefficient of thermal expansion of the first joining material is larger than a coefficient of thermal expansion of the second joining material.

8. The physical quantity detector according to claim 1, wherein the second joining material is a glass material.

9. The physical quantity detector according to claim 8, wherein the glass material contains metal particulates.

10. A method of manufacturing the physical quantity detector according to claim 1, wherein a melting point of the second joining material is higher than heating temperature in mounting the physical quantity detector on a substrate.

11. A method of manufacturing a physical quantity detector including:
a pressure sensitive element including:
a pair of bases; and
a pressure sensitive section arranged between the pair of bases;
a diaphragm including:
a flexible section including a pair of supporting sections to which the pair of bases are joined via a second joining material; and
a supporting frame section that supports a peripheral edge of the flexible section; and
a fixing section to which the supporting frame section is fixed via a first joining material having a melting point lower than a melting point of the second joining material, the method comprising:
applying the second joining material to the pair of supporting sections of the diaphragm;
provisionally baking the second joining material applied to the pair of supporting sections;
applying, more thickly than thickness of the second joining material, the first joining material to the supporting frame section on a principal plane side on which the supporting section is provided in the diaphragm;
provisionally baking the first joining material applied to the supporting frame section;
joining the supporting frame section of the diaphragm and the fixing section using the first joining material by heating the first joining material to temperature equal to or higher than the melting point of the first joining material and lower than the melting point of the second joining material; and
joining the pair of supporting sections of the diaphragm and the pair of bases of the pressure sensitive element using the second joining material by heating, in a state in which the second joining material and the pair of bases of the pressure sensitive element are set in contact with each other, the second joining material to temperature equal to or higher than the melting point of the second joining material.

12. The method of manufacturing the physical quantity detector according to claim 11, wherein, in the joining of the supporting frame section and the fixing section, the first joining material applied to the supporting frame section of the diaphragm and provisionally baked and a frame section surrounding the pressure sensitive section and having a function of the fixing section are brought into contact with each other and heated to temperature equal to or higher than the melting point of the first joining material and lower than the melting point of the second joining material to thereby join the supporting frame section and the frame section using the first joining material.

13. The physical quantity detector according to claim 3, wherein
portions joined by the first joining material are quartz crystal, and
a coefficient of thermal expansion of the first joining material is larger than a coefficient of thermal expansion of the second joining material.

14. The physical quantity detector according to claim 4, wherein
portions joined by the first joining material are quartz crystal, and
a coefficient of thermal expansion of the first joining material is larger than a coefficient of thermal expansion of the second joining material.

15. The physical quantity detector according to claim 2, wherein an absolute value of a difference between coefficients of thermal explanation of the first joining material and portions joined by the first joining material is smaller than an absolute value of a difference between coefficients of thermal expansion of the second joining material and portions jointed by the second joining material.

16. The physical quantity detector according to claim 2, further comprising a base including a function of the fixing section, wherein
the base and the diaphragm are laminated to cover the pressure sensitive element.

17. The physical quantity detector according to claim 2, further comprising:
a frame section that surrounds the pressure sensitive element; and
a connecting section that couples the frame section and the pressure sensitive element, wherein
the frame section includes a function of the fixing section.

18. The physical quantity detector according to claim 2, wherein
portions joined by the first joining material are quartz crystal, and
a coefficient of thermal expansion of the first joining material is larger than a coefficient of thermal expansion of the second joining material.
